(19) United States
(12) Patent Application Publication
(10) Pub. No.: US 2012/0255370 A1
(43) Pub. Date: Oct. 11, 2012

(54) Method for Trimming a Tube

(75) Inventors: Alfred Rieder, Landshut (DE); Wolfgang Drahm, Erding (DE); Michael Wiesmann, Freising (DE)

(73) Assignee: Endress + Hauser Flowtec AG, Reinach (DE)

(21) Appl. No.: 13/433,639

(22) Filed: Mar. 29, 2012

Related U.S. Application Data
(60) Provisional application No. 61/472,745, filed on Apr. 7, 2011.

(30) Foreign Application Priority Data
Apr. 7, 2011 (DE) 10 2011 00 6919.4

(51) Int. Cl. G01F 1/84; B24B 1/00; B23K 26/00; B23P 17/02; B26D 3/00

(52) U.S. Cl. 73/861.357; 29/401.1; 83/13; 219/121.72; 451/28

(57) ABSTRACT

A method for trimming a tube with at least one stiffening element placed on its tube wall to a target bending stiffness, wherein the tube has first an interim bending stiffness, which is greater than the target bending stiffness. For the purpose of reducing the interim bending stiffness of the tube to the target bending stiffness, it is provided in the method of the invention that volume of the stiffening element is removed, for instance, by means of a laser.

### CROSS-REFERENCE TO RELATED APPLICATION

This is a nonprovisional application which claims the benefit of U.S. Provisional Application No. 61/472,745, which was filed on Apr. 7, 2011.

### TECHNICAL FIELD

The invention relates to a method for trimming a tube, especially a tube serving as a measuring tube of a measuring transducer of the vibration-type, to a predeterminable target bending stiffness.

### BACKGROUND DISCUSSION

In industrial measurements technology, especially also in connection with the control and monitoring of automated manufacturing processes, for ascertaining characteristic measured variables of media flowing in a process line, for example, a pipeline, for example, of media such as liquids and/or gases, often such measuring systems are used, which, by means of a measuring transducer of vibration-type and a transmitter electronics connected thereto, most often a transmitter electronics accommodated in a separate electronics housing, induce in the flowing medium reaction forces, for example, Coriolis forces, and produce, repetitively derived from these, measured values, for example, mass flow rate, density, viscosity or some other process parameter correspondingly representing the at least one measured variable. Such measuring systems—often formed by means of an in-line measuring device in compact construction with integrated measuring transducer, such as, for instance, a Coriolis, mass flow meter,—are long known and have proven themselves in industrial use. Examples of such measuring systems with a measuring transducer of vibration-type or also individual components thereof, are described e.g. in EP-A 421 812, EP-A 462 711, EP-A 763 720, EP-A 1 248 084, U.S. Pat. Nos. 4,680,974, 4,738,144, 4,768,384, 4,801,897, 4,823,614, 4,879,911, 5,009,109, 5,050,439, 5,359,881, 5,602,345, 5,610,342, 5,734,112, 5,796,011, 5,926,096, 5,969,264, 7,127,952, 6,092,429, 6,311,136, 6,883,387, 7,325,461, 7,392,709, 7,421,350, 7,610,795, US-A 2010/0050783, US-A 2010/0251830, US-A 2010/0242623, WO-A 96/08697, WO-A 98/40702, WO-A 2004/099735, WO-A 2005/050145, WO-A 2007/040468, WO-A 2008/059015, WO-A 2010/059157 or the not pre-published German patent application DE 102009046043.8 of the company Endress Hauser.

Therein shown measuring transducers comprise at least two, essentially straight, or curved, e.g. U-, or V-shaped, equally constructed, measuring tubes accommodated in a measuring transducer housing for conveying the medium, in given cases, a medium that is also inhomogeneous, extremely hot and even very viscous. The at least two measuring tubes can, as, for example, shown in the mentioned U.S. Pat. Nos. 5,734,112, 5,796,011 or US-A 2010/0242623, be integrated into the process line via a flow divider extending on the inlet side between the measuring tubes and an inlet-side connecting flange as well as via a flow divider extending on the outlet side between the measuring tubes and an outlet-side connecting flange, in order to form a tube arrangement with flow paths connected in parallel with one another. The measuring tubes can, however, also, as shown, for example, in the mentioned EP-A 421 812, EP-A 462 711, EP-A 763 720, be integrated into the process line via in- and outlet tube pieces, in order to form a tube arrangement with a single traversing flow path. In measurement operation, the measuring tubes, which exhibit flow through—in parallel, or serially—are then caused to vibrate for the purpose of generating oscillation forms influenced by the medium flowing through.

Selected as excited oscillation form—the so-called wanted mode—is, in the case of measuring transducers with curved measuring tubes, usually that eigenoscillation form (eigenmode), in the case of which each of the measuring tubes moves as a cantilever in a pendulum-like manner at least partially at a natural resonance frequency (eigenfrequency) about an imaginary longitudinal axis of the measuring transducer, whereby Coriolis forces are induced in the through flowing medium as a function of the mass flow. These, in turn, lead to the fact that superimposed on the excited oscillations of the wanted mode, in the case of curved measuring tubes, thus the pendulum-like, cantilever oscillations, are thereto equal in frequency, bending oscillations according to at least one likewise natural, second oscillation form of, in comparison to the wanted mode, higher (modal) order, the so-called Coriolis mode. in the case of measuring transducers with a curved measuring tube, these cantilever oscillations in the Coriolis mode forced by Coriolis forces correspond usually to that eigenoscillation form, in the case of which the measuring tube also executes rotary oscillations about an imaginary vertical axis directed perpendicularly to the longitudinal axis. In the case of measuring transducers with a straight measuring tube, in contrast, for the purpose of producing mass flow dependent, Coriolis forces, often a wanted mode is selected, in the case of which each of the measuring tubes executes, at least partially, bending oscillations essentially in a single imaginary plane of oscillation, so that the oscillations in the Coriolis mode, accordingly, are embodied as bending oscillations of equal oscillation frequency coplanar with the wanted mode oscillations.

For active exciting of oscillations of the at least two measuring tubes, measuring transducers of a vibration-type have, additionally, an exciter mechanism driven, during operation, by an electrical driver signal, e.g. a controlled electrical current, generated and correspondingly conditioned by the mentioned transmitter electronics, and, respectively, a therein correspondingly provided, special driver circuit. The exciter mechanism excites the measuring tube by means of at least one electromechanical, especially electrodynamic, oscillation exciter through which electrical current flows and acting practically directly, especially differentially, on the at least two measuring tubes, such that they execute bending oscillations, especially opposite equal, bending oscillations, in the wanted mode. Furthermore, such measuring transducers include a sensor arrangement with oscillation sensors, especially electrodynamic, oscillation sensors, for the at least pointwise registering of inlet-side and outlet-side oscillations of at least one of the measuring tubes, especially opposite equal bending oscillations of the measuring tubes in the Coriolis mode, and for producing electrical sensor signals serving as vibration signals of the measuring transducer and influenced by the process parameter to be registered, such as, for instance, mass flow or density. As described, for example, in U.S. Pat. No. 7,325,461, in the case of measuring transducers of the type being discussed, in given cases, the oscillation exciter can also, at least at times, be used as oscillation sensor and/or an oscillation sensor at least at times as an oscillation exciter. The exciter mechanism of the measuring transducers of the type being discussed includes usually at least one electrodynamic oscillation exciter and/or an oscillation exciter acting differentially on the measuring tubes, while the sensor arrangement comprises an inlet-side, most often likewise electrodynamic, oscillation sensor as well as at least one thereto essentially equally constructed, outlet-side oscillation sensor. Such electrodynamic and/or differential oscillation exciters of usually marketed measuring transducers of vibration-type are formed by means of a magnet coil, through which electrical current flows, at least at times, and which is affixed on one of the measuring tubes, as well as by means of a permanent magnet interacting with the at least one magnet coil, especially plunging into such, serving as a rather elongated armature, especially with rod-shaped form, correspondingly affixed on the other, opposite equally moving, measuring tube. The permanent magnet and the magnet coil serving as exciter coil are, in such case, usually so oriented that they extend essentially coaxially relative to one another. Additionally, in the case of conventional measuring transducers, the exciter mechanism is usually embodied in such a manner and placed in the measuring transducer such that it acts essentially centrally on the measuring tubes. In such case, the oscillation exciter and, insofar, the exciter mechanism, is, as shown, for example, also in the case of that in the proposed measuring transducers, affixed outwardly on the respective measuring tube at least pointwise along an imaginary central peripheral line thereof. Alternatively to an exciter mechanism formed by means of oscillation exciters acting rather centrally and directly on the respective measuring tube, the exciter mechanism can, as, among other things, provided in U.S. Pat. No. 6,092,429 or U.S. Pat. No. 4,823,614, for example, also be formed by means of two oscillation exciters affixed, in each case, not in the center of the respective measuring tube, but, instead rather on the in-, and, respectively, outlet sides.

In the case of usually marketed measuring transducers of vibration-type, the oscillation sensors of the sensor arrangement are, at least insofar as they work according to the same principle of action, embodied with essentially the same construction as the at least one oscillation exciter. Accordingly, also the oscillation sensors of such a sensor arrangement are most often, in each case, formed by means of at least one magnet coil, which is affixed on one of the measuring tubes and, at least at times, passed through by a variable magnetic field and, associated therewith, supplied, at least at times, with an induced measurement voltage, as well as a permanently magnetic armature, which delivers the magnetic field, with the armature being affixed on another of the measuring tubes and interacting with the at least one coil. Each of the aforementioned coils is additionally connected by means of at least one pair of electrical connecting lines with the mentioned transmitter electronics of the in-line measuring device. These electrical connecting lines are led most often on as short as possible paths from the coils to the measuring transducer housing. Due to the superimposing of wanted- and Coriolis modes, the oscillations of the vibrating measuring tubes registered by means of the sensor arrangement on the inlet side and on the outlet side have a measurable phase difference also dependent on the mass flow. Usually, the measuring tubes of such measuring transducers applied, e.g. in Coriolis, mass flow meters are excited during operation to an instantaneous natural resonance frequency of the oscillation form selected for the wanted mode, e.g. at constant controlled oscillation amplitude. Since this resonance frequency depends, especially, also on the instantaneous density of the medium, market-usual Coriolis, mass flow meters can measure, besides mass flow, supplementally also the density of flowing media. Additionally, it is also possible, as, for example, shown in U.S. Pat. No. 6,651,513 or U.S. Pat. No. 7,080,564, by means of measuring transducers of vibration-type, directly to measure viscosity of the through flowing medium, for example, based on the exciter energy, or excitation power, required for maintaining the oscillations and/or based on the attenuation, or damping, of oscillations of the at least one measuring tube, especially oscillations in the aforementioned wanted mode, resulting from dissipation of oscillatory energy. Moreover, also other measured variables, such as, for instance, according to U.S. Pat. No. 6,513,393, the Reynolds number, derived from the aforementioned primary measured values, mass flow rate, density and viscosity, can be ascertained.

In the case of measuring transducers of the type being discussed, it is especially important to trim the oscillation characteristics of individual measuring transducer components, also not last, the at least one measuring tube, consequently the oscillation characteristics characterizing, or influencing, parameters, such as, for instance, tube shapes, and, respectively, cross sections, tube wall thicknesses and, associated therewith, mass distributions, bending stiffnesses, eigenfrequencies etc., of each individual measuring transducer example as exactly as possible at a target dimension therefor, in each case, predetermined for defined reference conditions, and, respectively, to hold the scattering of said parameters within a population of manufactured measuring transducers of such type in an as narrow as possible tolerance range predetermined therefor. In such case, it is, among other things, also of special interest, to set the eigenfrequencies of the respective tube arrangement of the measuring transducer to the desired target(s), here thus one or more selected target eigenfrequencies, at an, as much as possible, “late” production phase, in order to be able to prevent, reliably, possible newer detunings of the tube arrangement in a following production phase of the measuring transducer. In the initially mentioned U.S. Pat. No. 5,610,342, for example, a method for the dynamic tuning of a tube serving as a measuring tube of a measuring transducer of the vibration-type to a target stiffness is shown, in the case of which method the tube is pressed in on its two tube ends in bores of a first, and, respectively, second end piece of a support tube by targeted plastic deformation of the tube walls in the region of the tube ends and the entire tube arrangement is simultaneously adjusted to a target eigenfrequency. Additionally, in the initially mentioned U.S. Pat. No. 7,610,795, a method is described for tuning a tube serving as a measuring tube of a measuring transducer of the vibration-type to a target eigenfrequency, consequently to a target bending stiffness co-determined by the tube geometry and cross section, by means of a fluid introduced therein and supplied with an (over-) pressure introducing plastic deformation of at least of a part of its tube wall.

A disadvantage of the methods known from the state of the art is, among other things, that they are very complicated. Moreover, another disadvantage of the aforementioned methods is that, inherently therewith, ultimately a certain change of the geometry of the tubes, namely a deviation from the ideal circular shape of the cross section, or an increased deviation from perfect homogeneity of the cross section in the longitudinal direction, consequently a deviation of the contour of the lumen of the tube from the ideal form, is introduced.

### SUMMARY OF THE INVENTION

An object of the invention is, therefore, to provide a method that enables precise as well as simple tuning of one or more measuring tubes of measuring transducers of the type being discussed to a target bending stiffness, or to a target eigenfrequency, even in a phase of the manufacturing process for such a measuring transducer, in which the chosen tube arrangement has already been assembled, in given cases, also already equipped with oscillation exciter- and/or oscillation sensor components. All this should be accomplished as much as possible while avoiding plastic deformation of the tube.

For achieving the object, the invention resides in a method for trimming a tube to a target bending stiffness, especially a metal tube and/or a tube serving as a measuring tube of a measuring transducer of the vibration-type, such tube having a tube wall, for example, a tube wall of metal and/or an at least sectionally circularly cylindrical, tube wall, and at least one stiffening element, for example, a metal stiffening element and/or a stiffening element of a material bondable with the material of the tube and/or a platelet shaped stiffening element, placed on the tube wall, especially on an outer lateral surface of the tube wall and/or bonded thereto, whereby the tube has an interim bending stiffness, which is greater than the target bending stiffness, which method comprises a step of removing volume of the stiffening element for reducing the interim bending stiffness of the tube to the target bending stiffness. The tube trimmed according to the method of the invention to a target bending stiffness is suitable especially also for application in a measuring transducer of vibration-type, not last also in a measuring transducer of a Coriolis, mass flow, measuring device.

According to a first embodiment of the invention, it is additionally provided that at least one oscillation exciter is placed on the tube.

According to a second embodiment of the invention, it is additionally provided that at least one oscillation sensor is placed on the tube.

According to a third embodiment of the invention, it is additionally provided that laser light is used for removing volume of the stiffening element, wherein the laser light is applied, for example, by means of a gas laser, by means of a solid laser or also by means of a fiber laser.

According to a fourth embodiment of the invention, it is additionally provided that the removing of volume of the stiffening element comprises a step of cutting at least one slit or slot in the stiffening element.

According to a fifth embodiment of the invention, it is additionally provided that the removing of volume of the stiffening element comprises a step of grinding at least one notch in the stiffening element.

According to a sixth embodiment of the invention, it is additionally provided that the stiffening element is applied on the lateral surface of the tube by means of welding and/or soldering, for example, also hard soldering, or brazing.

According to a seventh embodiment of the invention, it is additionally provided that the stiffening element is rod or bar shaped.

According to an eighth embodiment of the invention, it is additionally provided that the stiffening element is plate shaped.

According to a ninth embodiment of the invention, it is additionally provided that the stiffening element is formed by means of wire, especially metal wire.

According to a tenth embodiment of the invention, it is additionally provided that the stiffening element is formed by means of a platelet, for example a metal platelet.

According to an eleventh embodiment of the invention, it is additionally provided that the stiffening element is formed by means of solder material applied on the lateral surface, for example, also beaded or spotted, solder material.

According to a twelfth embodiment of the invention, it is additionally provided that the stiffening element is formed by means of a ridge of solder material.

According to a first further development of the invention, the method also comprises a step of applying at least one additional stiffening element on a lateral surface of the tube, especially an additional stiffening element of metal and/or a material bondable with the material of the tube and/or a platelet shaped, additional stiffening element. The applying of the additional stiffening element on the lateral surface of the tube can, in such case, also comprise applying liquid solder material on the lateral surface of the tube as well as letting applied liquid solder material solidify on the lateral surface of the tube.

According to a second further development of the invention, the method further comprises a step of detecting whether the tube has been trimmed to the target bending stiffness, especially based on at least one mechanical eigenfrequency of said tube or a tube arrangement formed by means of the same.

According to a third further development of the invention, the method further comprises a step of ascertaining to what extent an instantaneous, interim, bending stiffness of the tube deviates from the target bending stiffness, for example, also based on at least one mechanical eigenfrequency of said tube.

According to a fourth further development of the invention, the method further comprises a step of ascertaining the target bending stiffness of the tube.

According to a fifth further development of the invention, the method further comprises a step of ascertaining the interim bending stiffness of the tube.

According to a sixth further development of the invention, the method further comprises a step of causing the tube to vibrate for ascertaining its interim bending stiffness.

According to a seventh further development of the invention, the method additionally comprises a step of forming a tube arrangement having the tube as well as a comparison tube mechanically coupled therewith. For ascertaining the target bending stiffness of the tube and/or for ascertaining the interim bending stiffness of the same, an option is, for example, also to cause the comparison tube also to vibrate at a mechanical eigenfrequency of said tube arrangement.

A basic idea of the invention is to trim a bending stiffness of a tube, especially a tube serving as a component of a measuring transducer of vibration-type, very simply, as well as also very effectively, to a corresponding, namely desired, target therefor, consequently a target bending stiffness, by applying an additional stiffening element on the tube, outwardly on its tube wall, for first increasing the bending stiffness of the tube, for instance, also comparably to the stiffening element serving in the initially mentioned U.S. Pat. No. 5,602,345 or WO-A 2010/059157 exclusively for separating eigenfrequencies of various eigenmodes of the respective tube arrangements, and thereafter reducing volume of said stiffening element by a certain amount, namely removing material of the stiffening element, so that, as a result of the therewith associated weakening of the stiffening element, the bending stiffness of the tube co-determined by such, and, respectively, a corresponding spring constant are reduced by a corresponding magnitude. In this way, the bending stiffness (spring constant) of a tube serving as a measuring tube of a measuring transducer of vibration-type can, even in a comparatively “late” phase of production, be very precisely brought to the desired target, in which then a renewed undefined detuning of the tube, consequently of the measuring transducer no longer needs to be cared for. A further advantage of the method is therewith to be seen in the fact that it is basically also applicable to conventional measuring transducers of vibration-type, and, consequently, can also find application in a conventional tube arrangement.

### BRIEF DESCRIPTION OF THE DRAWINGS

The invention as well as other advantageous embodiments and utilities thereof will now be explained in greater detail based on examples of embodiments shown in the figures of the drawing. Equal parts are provided in all of the figures with equal reference characters; when perspicuity requires or when it otherwise appears sensible, already mentioned reference characters are omitted in subsequent figures. Other advantageous embodiments or further developments, especially also combinations of first only individually explained aspects the invention, will become evident additionally from the figures of the drawing, as well as also from the dependent claims per se.

The figures of the drawing show as follows:

FIGS. 1, 2a and 2b are side and end views, of a measuring system embodied as a compact measuring device for measuring media flowing in pipelines;

FIG. 3 is a schematic block diagram of a transmitter electronics with measuring transducer of vibration-type connected thereto, especially a transmitter electronics suitable for a measuring system according to FIGS. 1, 2;

FIGS. 4 and 5 are partially sectioned, perspective views of a measuring transducer of vibration-type, especially a measuring transducer of vibration-type suited for a measuring system according to FIGS. 1, 2; and

FIG. 6 is a section of a tube, especially a tube also suited as a measuring tube for a measuring transducer according to FIGS. 4, 5, with a stiffening element placed thereon.

### DETAILED DESCRIPTION IN CONJUNCTION WITH THE DRAWINGS

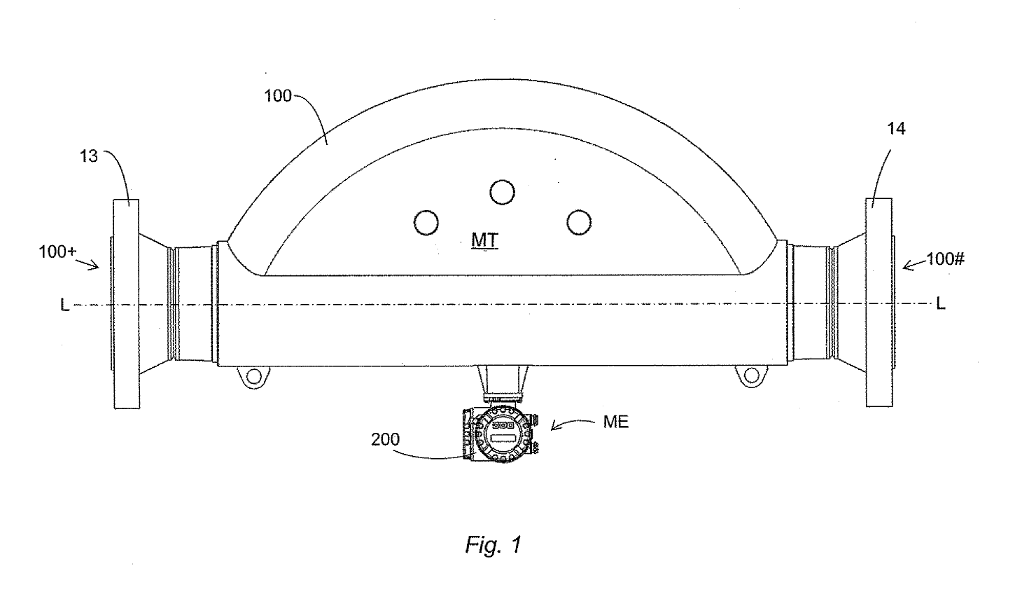

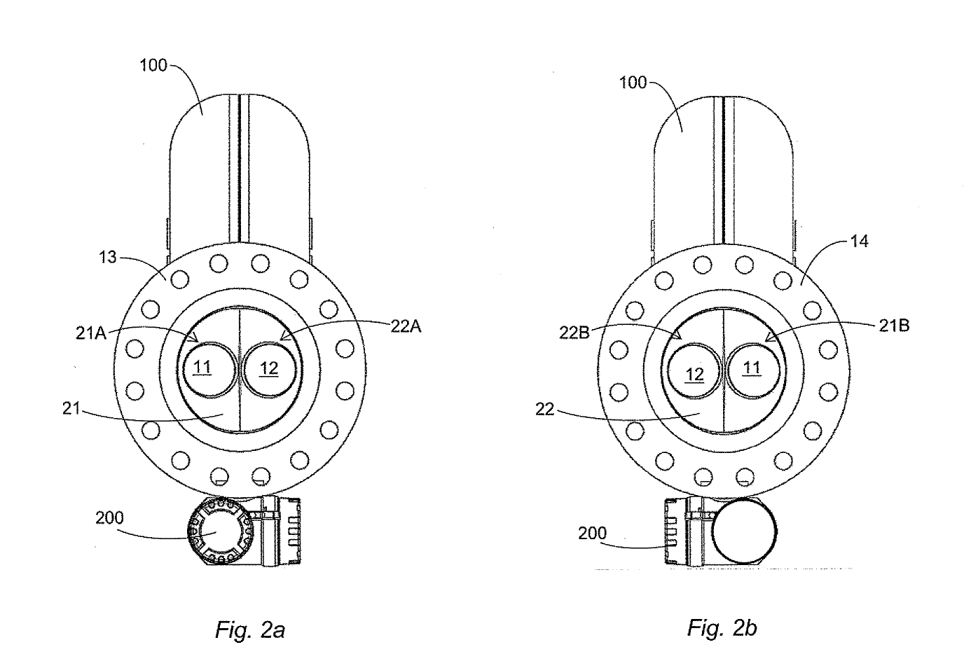

FIGS. 1, 2a, 2b show schematically an example of an embodiment of a measuring system embodied, for example, as a Coriolis mass flow measuring device, density measuring device, viscosity measuring device or the like, insertable in a process line (not shown), for instance, a pipeline of an industrial plant, for measuring flowable, especially fluid, media, especially, measuring and/or monitoring at least one physical parameter of a medium, such as, for instance, mass flow rate, density, viscosity or the like. The measuring system—implemented here as an in-line measuring device in compact construction—comprises therefor a measuring transducer MT connected to the process line via an inlet end 100+ as well as an outlet end 100# and serving for registering the at least one parameter and its conversion into measurement signals representative thereof. During operation, the medium to be measured, such as, for instance, a low viscosity liquid and/or a high viscosity paste, flows through the measuring transducer, which is connected in the measuring system with a transmitter electronics ME electrically coupled with the measuring transducer and serving for activating the measuring transducer and for evaluating measuring signals delivered by the measuring transducer.

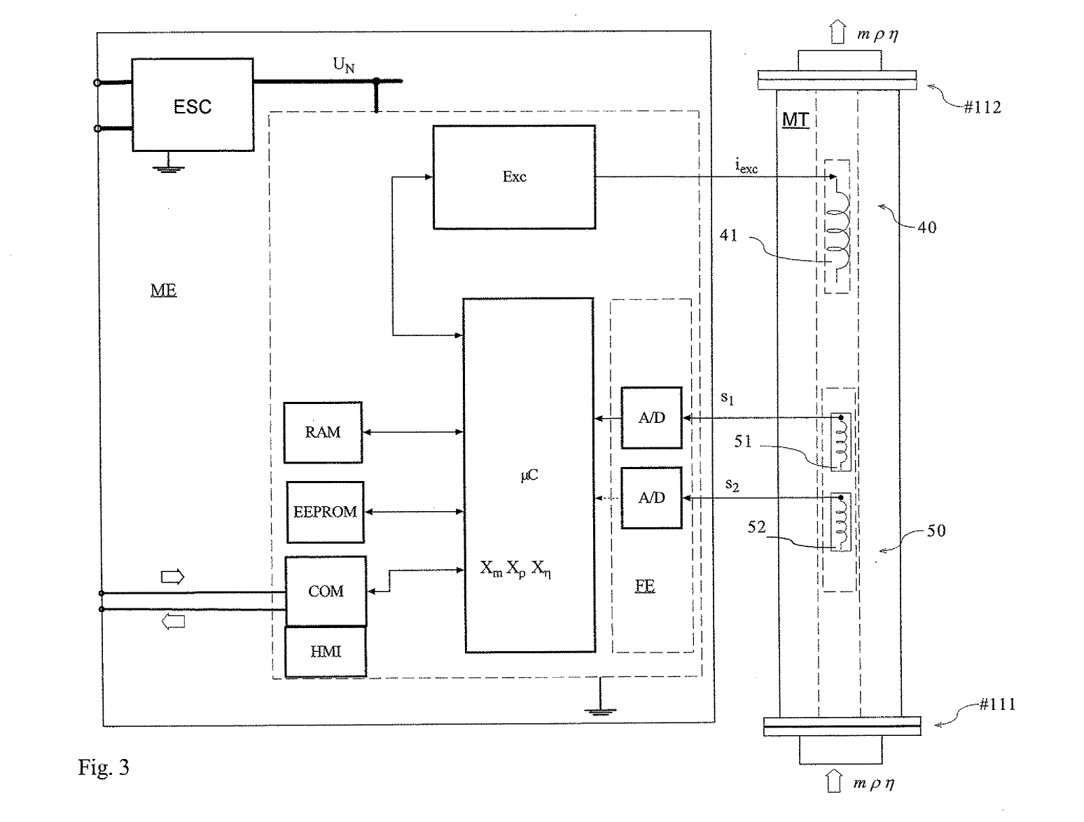

The transmitter electronics, especially a transmitter electronics supplied during operation with electrical energy from the exterior via connecting cable and/or by means of an internal energy storer, includes, as shown in FIG. 3 schematically and in the manner of a block diagram, a driver circuit Exc serving for activating the measuring transducer, for example, a measuring transducer of vibration-type, as well as a measuring and evaluating circuit μC for processing measurement signals of the measuring transducer MT. The measuring and evaluating circuit is formed, for example, by means of a microcomputer and/or communicates during operation with the driver circuit Exc. During operation, the measuring and evaluating circuit delivers measured values representing the at least one measured variable, such as e.g. the instantaneous, or totaled, mass flow. The driver circuit Exc and the evaluating circuit μC as well as other electronic components of the transmitter electronics serving for the operation of the measuring system, such as, for instance, internal energy supply circuits ESC for providing internal supply voltages UN and/or communication circuits COM serving for connection to a superordinated, measurement data processing system and/or to a fieldbus, are, furthermore, accommodated in a corresponding electronics housing 200, especially an impact- and/or also explosion resistant and/or hermetically sealed, electronics housing 200. The electronics housing 200 of the inline measuring device can be held, for example, directly on the measuring transducer housing 100, to form a measuring device in compact construction. For visualizing, on-site, measured values produced internally in the measuring system and/or, in given cases, measuring system internally generated status reports, such as, for instance, an error report or an alarm, the measuring system can have, furthermore, a display- and operating element HMI communicating, at least at times, with the transmitter electronics, such as, for instance, an LCD, OLD or TFT display placed in the electronics housing behind a window provided correspondingly therein as well as a corresponding input keypad and/or a screen with touch input, such as used in, among other things, also in so-called smartphones. In advantageous manner, the transmitter electronics ME, especially a programmable and/or remotely parameterable, transmitter electronics ME, can additionally be so designed that it can, during operation of the in-line measuring device, exchange data with a superordinated electronic data processing system, for example, a programmable logic controller (PLC), a personal computer and/or a work station, via a data transmission system, for example, a fieldbus system and/or wirelessly via radio, for instance, measuring- and/or other operating data, such as, for instance, current measured values or tuning values serving for control of the inline-measuring device and/or diagnostic values. In such case, the transmitter electronics ME can have, for example, an internal energy supply circuit ESC, which is fed, during operation, via the aforementioned fieldbus system, from an external energy supply provided in the data processing system. In an embodiment of the invention, the transmitter electronics is additionally so embodied that it is electrically connectable with the external electronic data processing system by means of a two-wire connection 2L, for example, a two-wire connection 21, configured as a 4-20 mA current loop, and can be supplied thereby with electrical energy as well as transmit therethrough measured values to the data processing system. For the case, in which the measuring system is provided for coupling to a fieldbus- or some other communication system, the transmitter electronics ME can have a corresponding communication interface COM for data communication according to one of the relevant industry standards. The electrical connecting of the measuring transducer to the mentioned transmitter electronics can occur by means of corresponding connecting lines, which lead from the electronics housing 200, for example, via cable feed-through, and extend at least sectionally within the measuring transducer housing. The connecting lines can, in such case, be embodied at least partially as electrical line wires encased, at least sectionally, in an electrical insulation, e.g. electrical line wires in the form of “twisted pair” lines, flat ribbon cables and/or coaxial cables. Alternatively thereto or in supplementation thereof, the connecting lines can, at least sectionally, be formed also by means of conductive traces of a circuit board, especially a flexible circuit board, in given cases, a lacquered circuit board; compare, for this, also the initially mentioned U.S. Pat. No. 6,711,958 or U.S. Pat. No. 5,349,872.

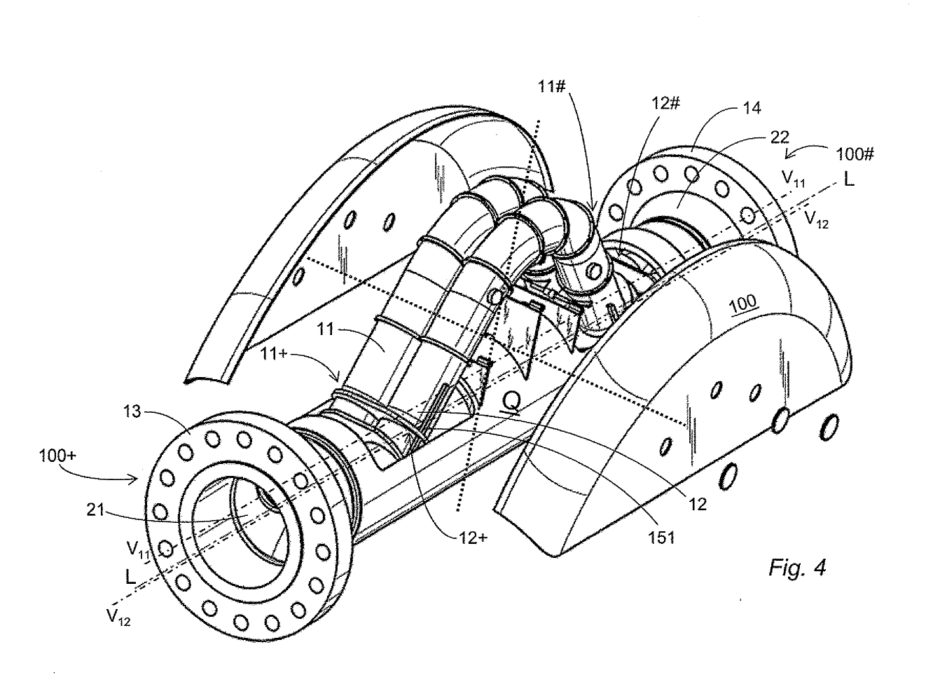

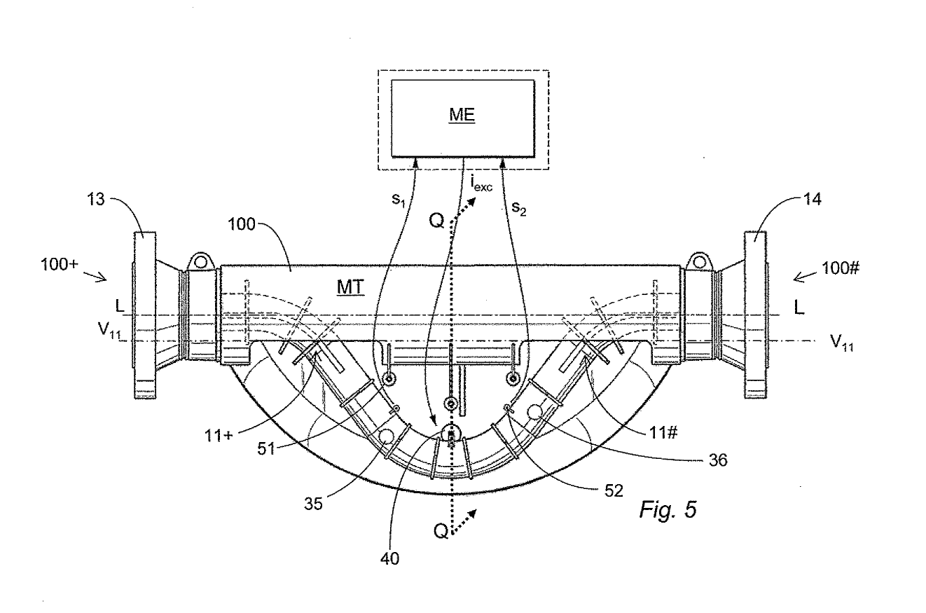

Schematically shown in FIGS. 4 and 5 additionally is an example of an embodiment of a measuring transducer MT suited for implementing the measuring system. The measuring transducer MT shown here is embodied as a measuring transducer of vibration-type and serves generally for producing in a through flowing medium, for instance, a gas and/or a liquid, mechanical reaction forces, e.g. mass flow dependent, Coriolis forces, density dependent, inertial forces and/or viscosity dependent, frictional forces, which react registerably by sensor, and, insofar, also measurably, on the measuring transducer. Derived from these reaction forces, e.g. the parameters, mass flow rate m, density ρ and viscosity η of the medium can be measured.

For registering the at least one parameter, the measuring transducer comprises an inner part arranged in a measuring transducer housing 100 and driven during operation by the transmitter electronics ME, which effects the physical-to-electrical transducing of the at least one parameter to be measured.

For conveying the flowing medium, the inner part, and, thus, the measuring transducer, shown here, includes, in an embodiment of the invention, additionally, an inlet-side, first flow divider 21 having at least two mutually spaced flow openings 21A, 21B and serving for dividing inflowing medium into two flow portions, an outlet-side, second flow divider 22 having at least two mutually spaced flow openings 22A, 22B and serving for guiding the flow portions back together, as well as at least two tubes 11, 12 connected to the flow dividers 21, 22, especially equally-constructed flow dividers 21, 22, to form a tube arrangement having at least two flow paths connected for parallel flow and to serve ultimately as measuring tubes, through which the medium to be measured flows. In such case, a first tube 11 opens with an inlet-side, first tube end into a first flow opening 21A of the first flow divider 21 and with an outlet-side, second tube end into a first flow opening 22A of the second flow divider 22 and a second tube 12 with an inlet-side, first tube end into a second flow opening 21B of the first flow divider 21 and with an outlet-side, second tube end into a second flow opening 22B of the second flow divider 202, so that, thus, in the case of this embodiment of the invention, medium flows through the two (measuring-) tubes (which are also mechanically coupled with one another) simultaneously and in parallel in the undisturbed operation of the measuring system. The two tubes 11, 12 can be connected with the flow dividers, for example, by material bonding, for instance, by welding or brazing or soldering, or also by force, e.g. friction, interlocking, for instance, by roll expansion according to the initially mentioned U.S. Pat. No. 5,610,342. In the example of an embodiment shown here, the flow dividers are integral components of the measuring transducer housing, as the first flow divider forms an inlet-side, first housing end defining the inlet end 100+ of the measuring transducer and the second flow divider an outlet-side, second housing end defining the outlet end 100# of the measuring transducer. For the typical case, in which the measuring transducer MT is to be assembled releasably with the process line, for example, a process line in the form of a metal pipeline, there are provided on the inlet side of the measuring transducer a first connecting flange 13 for connecting to a line segment of the process line supplying medium to the measuring transducer and on the outlet side a second connecting flange 14 for connecting to a line segment of the process line removing medium from the measuring transducer. The connecting flanges 13, 14 can, in such case, as quite usual in the case of measuring transducers of the described type, also be welded to the respective housing ends and, insofar, be integrated terminally into the measuring transducer housing 100.

In the example of an embodiment shown here, each of the two tubes 11, 12 extending, in each case, between its inlet-side, first tube end 11+, respectively 12+, and its outlet-side, second tube end 11#, respectively 12#, with an—essentially freely oscillating—wanted-oscillatory length, is, additionally, at least sectionally, curved. For producing the aforementioned, reaction forces, each of the two tubes is caused, during operation, to vibrate, at least over its oscillatory length—with, for example, equal oscillation frequency as the, respectively, other tube, however, opposite-equally thereto—and, in such case, is repeatedly elastically deformed oscillatingly about a static resting position. The respective oscillatory lengths correspond, in such case, to a length of an imaginary middle- or also centroidal, axis (imaginary connecting line through the centers of gravity of all cross sectional areas of the respective tube) extending within the lumens of the tubes, in the case of a curved tube, thus, a stretched length of the respective tube 11, 12. According to an additional embodiment of the invention, each of the tubes is so caused to vibrate during operation that each oscillates, especially in a bending oscillation mode, about an oscillation axis, which is, in each case, parallel to one of the two imaginary connecting axis V11, or V12 imaginarily connecting the respective tube ends 11+, 11#, and 12+, 12#.

The tubes, for example, tubes oscillating essentially opposite-equally to one another during operation, are, furthermore, mechanically connected with one another on the inlet side by means of a first coupling element 25, for example, a plate-shaped, first coupling element 25, to form a first coupling zone and on the outlet side by means of a second coupling element 26, for example, a plate-shaped, second coupling element 26, to form a second coupling zone. Thus, here, the first coupling zone defines, in each case, an inlet-side, first tube end 11+, 12+ adjoining the inlet side of the wanted oscillatory length of each of the two tubes 11, 12, and the second coupling zone, in each case, an outlet-side, second tube end 11#, 12# of the respective tubes 11, 12. As additionally evident from the combination of FIGS. 4 and 5, the coupling element 25 is arranged equally far from the first housing end of the measuring transducer housing, as the second coupling element 26 is from the second housing end of the measuring transducer housing. Each of the measuring tubes is, in the example of an embodiment shown here, additionally so formed and arranged in the measuring transducer that its aforementioned connecting axis extends essentially parallel to an imaginary longitudinal axis L of the measuring transducer imaginarily connecting the in- and outlet ends of the measuring transducer. Each of the measuring transducer measuring tubes (manufactured, for example, of stainless steel, titanium, tantalum, or zirconium or an alloy thereof), and, insofar, also an imaginary center line of the respective measuring tube extending within its lumen, can e.g. be embodied essentially U-shaped or, as well as also shown in FIGS. 4 and 5, essentially V-shaped.

As directly evident from the combination of FIGS. 4 and 5, each of the at least two tubes 11, 12 is here additionally, in each case, so formed and arranged that the aforementioned center line, as quite usual in the case of measuring transducers of the type being discussed, lies, in each case, in an imaginary tube plane and the aforementioned two connecting axis V11, V12 extend parallel to one another, and, consequently, perpendicularly to an imaginary middle plane Q of the tube arrangement, for example, also such that the two imaginary tube planes are parallel to one another.

In an additional embodiment of the invention, the tubes 11, 12 and the two coupling elements 25, 26 are additionally so formed and oriented relative to one another that the two coupling elements 25, 26 are equidistant relative to said middle plane of the tube arrangement, such that, consequently, a center of mass M25 of the first coupling element 25 is equally far from said middle plane as is a center of mass M26 of the second coupling element 26. The frequency adjusting effect of coupling elements of the aforementioned type results, in such case, as is known, from the fact that each of the two coupling elements has, in each case, a bending stiffness also about an imaginary longitudinal axis of the tube arrangement imaginarily connecting the center of mass M25 of the first coupling element 25 and the center of mass of the second coupling element 26, especially an imaginary longitudinal axis imaginarily cutting the first coupling element with a same intersection as the second coupling element, which bending stiffness, in each case, produces a contribution to a total stiffness not lastly also dependent on the (individual-) bending stiffnesses the tubes and co-determining the eigenfrequencies of the tube arrangement.

It is to be noted here, additionally, that—although the measuring transducer in the example of an embodiment shown in FIGS. 4 and 5 has two curved measuring tubes and at least, insofar, in its mechanical construction, as well as also in its principle of action, resembles the measuring transducers proposed in U.S. Pat. No. 6,920,798 or U.S. Pat. No. 5,796,011, or also available from the assignee under the designations “PROMASS E” or “PROMASS F”,—the invention, nevertheless, can also be applied to measuring transducers with straight and/or more than two measuring tubes, for example, thus four parallel measuring tubes, for instance, comparable to those shown in the initially mentioned U.S. Pat. No. 5,602,345 or WO-A 96/08697 or, for example, also available from the assignee under the designation “PROMASS M”. Furthermore, the measuring transducer can, however, also be formed by means of a tube arrangement having only a single measuring tube conveying medium during operation, coupled with a blind, or also balancing, tube, comparable thus, for instance, to the measuring transducers shown in U.S. Pat. No. 5,531,126 or U.S. Pat. No. 6,666,098 or, for example, also available from the assignee under the designation “PROMASS H”.

For the active exciting of mechanical oscillations of the at least two tubes, especially also mutually parallel tubes and/or tubes equally-constructed as regards shape and material, especially to one or more of their natural eigenfrequencies dependent on the density of the medium instantaneously conveyed therein, the measuring transducer is additionally provided with an electromechanical exciter mechanism 40, especially an electrodynamic one, thus one formed by means of a plunging armature coil, or solenoid. This serves, operated by an exciter signal, e.g. an exciter signal with a controlled electrical current and/or a controlled voltage, delivered by the driver circuit of the transmitter electronics and, in given cases, correspondingly conditioned by interaction with the measuring and evaluating circuit—, in each case, to convert electrical exciter energy, or power, Eexc fed by means of the driver circuit into an exciter force Fexc acting, e.g. with pulse shape or harmonically, on the at least two tubes and deflecting these in the above-described manner. The exciter force Fexc can, as usual in the case of such measuring transducers, be bidirectional or unidirectional and in manner known to those skilled in the art, be tuned e.g. by means of an electrical current, and/or voltage, control circuit as regards its amplitude and be matched, e.g. by means of a phase control loop (PLL), as regards its frequency, to an instantaneous mechanical eigenfrequency of the tube arrangement. The construction and application of such a phase control loop serving for tuning an exciter frequency, fexc, of the exciter signal to the instantaneous eigenfrequency of the desired wanted mode is described at length e.g. in U.S. Pat. No. 4,801,897. Of course, also other driver circuits, known, per se, to those skilled in the art to be suitable for tuning the exciter energy Eexc, can be used, for example, also those disclosed in the initially mentioned U.S. Pat. Nos. 4,879,911, 5,009,109, 5,050,439, or U.S. Pat. No. 6,311,136. Additionally, as regards application of such driver circuits for measuring transducers of vibration-type, reference is made to the transmitter electronics provided with measurement transmitters of the series, “PROMASS 83”, as available from the assignee, for example, in connection with measuring transducers of the series “PROMASS E”, “PROMASS F”, “PROMASS M”, or also “PROMASS H”. Their driver circuit is, for example, in each case, so embodied that the lateral bending oscillations in the wanted mode are controlled to a constant amplitude, thus an amplitude also largely independent of the density, ρ.

According to an additional embodiment of the invention, the at least two tubes 11, 12 are actively excited during operation by means of the exciter mechanism, at least at times, in a wanted mode, in which they execute, especially predominantly or exclusively, bending oscillations about the mentioned imaginary oscillation axis, for example, predominantly with exactly one natural eigenfrequency (resonance frequency) of the tube arrangement, such as, for instance, that corresponding to a bending oscillation fundamental mode, in which each of the tubes has exactly one oscillatory antinode within its respective wanted oscillatory length. Especially, in such case, it is additionally provided that each of the tubes, as quite usual in the case of such measuring transducers with curved tubes, is so excited by means of the exciter mechanism to bending oscillations at an exciter frequency, fexc, that it oscillates in the wanted mode about the mentioned imaginary oscillation axis—, for instance, in the manner of a unilaterally clamped cantilever—, at least partially according to one of its natural bending oscillation forms. The bending oscillations of the tubes actively excited by means of the exciter mechanism have, in such case, in the region of the inlet-side coupling zone defining the respective inlet-side tube ends, an inlet-side oscillation node, and, in the region of the outlet-side coupling zone defining the respective outlet-side tube ends, an outlet-side oscillation node, so that thus the respective tubes extend essentially freely oscillatingly with their oscillatory lengths between these two oscillation nodes.

As quite usual in the case of measuring transducers with a tube arrangement of the type being discussed, the tubes are, in such case, especially so excited by means of the exciter mechanism acting, for example, differentially between the two tubes that they execute during operation, at least at times, and at least partially, opposite-equal bending oscillations about the longitudinal axis L. In other words, the two tubes 11, 12 move, in each case, in manner of tuning fork tines oscillating relative to one another. For this case, according to an additional embodiment of the invention, the exciter mechanism is designed to excite, and, respectively, to maintain, opposite-equal vibrations of the first tube and of the second tube, especially bending oscillations of each of the tubes, about an imaginary oscillation axis imaginarily connecting the respective first tube ends and the respective second tube ends. Serving as exciter mechanism 40 can be, in such case, e.g. an exciter mechanism 40 formed in conventional manner by means of an electrodynamic oscillation exciter 41—, for example, a single electrodynamic oscillation exciter 41—placed centrally, thus in the region of a half oscillatory length, between the at least two tubes and acting differentially on the tubes. The oscillation exciter 41 can be formed, as indicated in FIG. 4, for example, by means of an cylindrical exciter coil, which is secured on the first tube and through which, during operation, a corresponding exciter current flows, and which, associated therewith, is permeated by a corresponding magnetic field, as well as by means of a permanently magnetic armature at least partially plunging into the exciter coil and affixed externally, especially centrally, on the second tube. Other—also quite suitable for the measuring system of the invention—exciter mechanisms for oscillations of the at least two tubes are shown e.g. in the initially mentioned U.S. Pat. Nos. 4,680,974, 4,738,144, 4,768,384, 4,801,897, 4,823,614, 4,879,911, 5,009,109, 5,050,439, 5,359,881, 5,602,345, 5,734,112, 5,796,011, 5,926,096, 5,969,264, 7,127,952, 6,092,429, 6,311,136, 6,883,387, 7,325,461, 7,392,709, or U.S. Pat. No. 7,421,350.

For causing the at least two tubes of the measuring transducer to vibrate, the exciter mechanism 40 is, as already mentioned, fed by means of a likewise oscillating, exciter signal of adjustable exciter frequency, fexc, so that an exciter current iexc, appropriately controlled in its amplitude, flows, during operation, through the exciter coil of the—here single oscillation exciter acting on the tube 10—, whereby a magnetic field required for moving the tubes is produced. The driver, or also exciter, signal, and, respectively, its exciter current iexc can be formed e.g. harmonically, multifrequently or also rectangularly. The exciter frequency, fexc, of the exciter current required for maintaining the actively excited vibrations of the tubes can, in the case of the measuring transducer shown in the example of an embodiment, in advantageous manner, be so selected, and set, that the tubes, as already mentioned, oscillate predominantly in a bending oscillation, fundamental mode.

For the operationally provided case, in which medium is flowing in the process line and, thus, the mass flow m in the tube arrangement is different from zero, also Coriolis forces are induced in the through flowing medium by means of the tubes vibrating in the above described manner. These, in turn, react on each tube, through which medium is flowing, and, so, effect an additional deformation of such, registerable by sensor. This deformation is essentially according to an additional natural eigenoscillation form of higher modal order than the wanted mode. An instantaneous embodiment of this so-called Coriolis mode superimposed with equal frequency on the excited, wanted mode is, in such case, especially as regards its amplitude, also dependent on the instantaneous mass flow m. Serving as Coriolis mode can be, as usual in the case of measuring transducers with curved tubes, e.g. the eigenoscillation form of the antisymmetric twist mode, thus that, in the case of which the respectively flowed through tube, as already mentioned, executes also rotary oscillations about an imaginary rotary oscillation axis directed perpendicularly to bending oscillation axis and imaginarily cutting the center line of the respective tube in the region of the half oscillatory length.

The measuring transducer additionally includes a corresponding sensor arrangement 50 for registering vibrations of the tubes, especially also oscillations in the Coriolis mode. This comprises, as also shown schematically in FIGS. 4 and 5, at least a first oscillation sensor 51, for example, an electrodynamic, first oscillation sensor 51 and/or a first oscillation sensor 51 spaced from the at least one oscillation exciter and arranged between the at least two tubes 10, for delivering a first vibration measurement signal s1 of the measuring transducer representing vibrations of at least one of the two tubes, for example, also opposite-equal vibrations of the at least two tubes, for example, a voltage corresponding to the oscillations or an electrical current corresponding to the oscillations. Additionally, according to a further development of the invention, it is provided that the sensor arrangement has at least a second oscillation sensor 52, for example, a second oscillation sensor 52 spaced from the first oscillation sensor 52 and arranged between the at least two tubes 10 and/or an electrodynamic, second oscillation sensor 52, for delivering a second vibration measurement signal s2 of the measuring transducer representing vibrations of at least one of the two tubes, for example, also opposite-equal vibrations of the at least two tubes. The oscillation sensors of the sensor arrangement can in advantageous manner additionally be so embodied that they deliver vibration measurement signals of equal type, for example, in each case, a signal voltage, or a signal current. In the example of an embodiment shown here, the first oscillation sensor 51 is arranged between the at least two tubes 10 on the inlet side and the second oscillation sensor between the at least two tubes 10 on the outlet side, especially the second oscillation sensor 52 is spaced equally from the at least one oscillation exciter, or from the half-length center of the tube 10, as the first oscillation sensor, and in such a manner, that the two sensors differentially register opposite-equal vibrations of the two tubes. The oscillation sensors of the sensor arrangement can, however, for example, also be so embodied and arranged in the measuring transducer that they, as, among other things, provided also in US-A 5,602,345, register the oscillations relatively to the measuring transducer housing.

@Each of the—typically broadband—vibration signals s1, s2 of the measuring transducer MT includes, in such case, a signal component corresponding to the wanted mode with a signal frequency corresponding to the instantaneous oscillation frequency, fexc, of the tubes oscillating in the actively excited, wanted mode and a phase shift, dependent on the current mass flow of the medium flowing in the tube arrangement, relative to the exciter signal iexc generated, for example, by means of a PLL circuit as a function of a phase difference existing between at least one of the vibration signals s1, s2 and the exciter current in the exciter mechanism. Even in the case of application of a rather broadband exciter signal iexc, as a result of the most often very high oscillation quality factor of the measuring transducer MT, it can be assumed therefrom that the signal component corresponding to the wanted mode of each of the vibration signals predominates over other signal components, especially signal components corresponding to possible external disturbances and/or classified as noise, and, insofar, also is dominating, at least within a frequency range corresponding to the bandwidth of the wanted mode.

The measuring transducer, vibration measurement signals s1, s2, each having a signal component with an instantaneous oscillation frequency, fexc, of the signal frequency corresponding to the at least two tubes oscillating in the actively excited, wanted mode, are, as well as also shown in FIG. 3, fed to the transmitter electronics ME and therein to the measuring- and evaluating circuit pC, where they are first preprocessed, especially preamplified, filtered and digitized by means of a corresponding input circuit FE, in order then to be able to be suitably evaluated. Applied as input circuit FE, as well as also as measuring- and evaluating circuit μC, can, in such case, be circuit technologies already applied and established in conventional Coriolis, mass flow, measuring devices, for example, also such applied according to the initially mentioned state of the art, for the purpose of making use of the vibration signals, and, particularly, for instance, ascertaining mass flow rates and/or totalled mass flows, etc. According to an additional embodiment of the invention, the measuring- and evaluating circuit μC is accordingly also provided by means of a microcomputer in the transmitter electronics ME, for example, implemented by means of a digital signal processor (DSP), and by means of program-code correspondingly implemented and running therein. The program code can be stored persistently e.g. in a non-volatile data memory EEPROM of the microcomputer and loaded at the booting of the same into a volatile data memory RAM, e.g. one integrated in the microcomputer. Suitable processors for such applications include e.g. those of type TMS320VC33, as available from the firm, Texas Instruments Inc. Of course, the vibration signals s1, s2 are, as already indicated, converted by means of corresponding analog to digital-converters A/D of the transmitter electronics ME into corresponding digital signals for processing in the microcomputer; compare, for this, for example, the initially mentioned U.S. Pat. No. 6,311,136 or U.S. Pat. No. 6,073,495 or also the aforementioned measurement transmitters of the series “PROMASS 83”.

The transmitter electronics ME, respectively the therein contained measuring- and evaluating circuit μC, serves, in such case, according to an additional embodiment of the invention, with application of the vibration measurement signals s1, s2 delivered by the sensor arrangement 50, for example, based on a phase difference detected between the vibration signals s1, s2 of the first and second oscillation sensor 51, 52 generated in the case of tube 10 oscillating partially in the wanted- and partially in the Coriolis mode, recurringly to ascertain a mass flow, measured value Xm, which represents a mass flow rate of the medium flowing in the measuring transducer. For such purpose, the transmitter electronics produces during operation, according to an additional embodiment of the invention, recurringly a phase difference, measured value x_{Δφ}, which represents, instantaneously, the phase difference, Δ_{φ}, existing between the first vibration signal s1 and the second vibration signal s2. Alternatively to, or in supplementation of, ascertaining the mass flow, measured value Xm, the transmitter electronics ME of the measuring system can also serve to produce, derived from an instantaneous oscillation frequency, especially that of the actively excited, wanted mode, especially an instantaneous oscillation frequency based on the vibration measurement signals or ascertained from the exciter signal, a density measured value, which represents a density of the medium flowing in the measuring transducer. Additionally, the transmitter electronics ME can, as quite usual in the case of in-line measuring devices of the type being discussed, be used in given cases, also to ascertain a viscosity measured value x_{η}representing a viscosity of the medium flowing in the measuring transducer; compare, for this, also the initially mentioned U.S. Pat. Nos. 7,284,449, 7,017,424, 6,910,366, 6,840,109, 5,576,500 or U.S. Pat. Nos. 6,651,513. Suited for ascertaining the exciter energy or excitation power, or damping, required for determining viscosity is, in such case, for example, the exciter signal delivered by the driver circuit of the transmitter electronics, especially an amplitude and frequency of its electrical current component driving the wanted mode or also an amplitude of the total exciter current, in given cases, also normalized on an oscillation amplitude ascertained based on at least one of the vibration signals. Alternatively thereto or in supplementation thereof, however, also an internal control signal serving for tuning the driver signal, or the exciter current, or, for example, in the case of exciting the vibrations of the at least one tube with an exciter current of fixedly predetermined amplitude, or an amplitude controlled to be constant, also at least one of the vibration signals, especially an amplitude thereof, can serve as a measure of the exciter energy or excitation power, or attenuation, or damping, required for ascertaining the viscosity measured value.

As already mentioned, there is, in the case of tube arrangements of the type being discussed, consequently also measuring transducers of vibration-type formed therewith, a special requirement that their eigenfrequencies—, in any event, however, also the eigenfrequency of the mentioned wanted mode under reference conditions—, in each case, be set as exactly as possible to a target eigenfrequency predetermined for defined reference conditions, or at least to trim a bending stiffness of at least one measuring tube co-determining said eigenfrequency, in each case, to a corresponding target bending stiffness, EJ. Serving as reference, in such case, can be, for example, a tube arrangement open to the atmosphere, and, consequently, conveying only air, at room temperature, thus, for instance, 20° C., or the target eigenfrequencies, or -bending stiffnesses ascertained for such a tube arrangement earlier. The method of the invention aims to increase the precision, with which such a tuning of one or more measuring tubes is performed as regards at least one target eigenfreguency and/or the at least one target bending stiffness EJ, and to make said tuning as simple as possible. For implementing the invention, a corresponding, starting tube, which will finally serve as measuring tube 11 of a measuring transducer of the aforementioned type, is provided in the course of the manufacturing process of the corresponding measuring transducer having a—here of metal and, at least sectionally, circularly cylindrical—tube wall first with at least one additional stiffening element 151, in such a manner, that the stiffening element 151 is placed on the tube wall, namely on an outer lateral surface of the tube wall. As a result of this, thus the so formed tube includes thereafter an interim bending stiffness EJ′, which is greater than an initial-stiffness EJ0 of said starting tube determined by material and shape of the starting tube and thus, insofar, earlier also sufficiently exactly known. Although it is, for those skilled in the art, not difficultly recognizable from the preceding explanations, let it be indicated here yet again, in summary, that the terms “starting tube”, “tube” and “measuring tube” refer, in each case, insofar, to the same object, thus the same tube body at different phases of fabrication, or as it exists in the intended application, while the term “tube arrangement” concerns, in each case, the same tube body, in each case, terminally fixedly clamped in a manner regularly enabling bending oscillations of the same.

Stiffening element 151 is, according to an embodiment of the invention, composed of a material connectable by bonding, for instance, by welding or (hard-) soldering, with the material of the starting tube, and, consequently, also the material of the finally formed tube. Thus, for example, stiffening element 151 is formed of the same metal as the starting tube. Stiffening element 151 can, moreover, be plate shaped, or rod or bar shaped, and, thus, be elongated in character. Therefore, serving as stiffening element can be, for example, a platelet, a flat bar or even a simple piece of metal wire. The stiffening element can, however, be formed e.g. in simple manner also just by means of solder or weld material deposited on the lateral surface, for instance, in the form of an elongated ridge or spotwise, thus, for example, in the form of a weld bead or just an area of deposited weld material. Accordingly, the applying of the stiffening element on the lateral surface of the tube comprises, in an additional embodiment of the method of the invention, also steps of welding and/or soldering. For the latter case, the applying of the stiffening element on the lateral surface of the tube, thus, includes also applying liquid solder material on the lateral surface of the tube and letting applied liquid solder material solidify on the lateral surface of the tube. According to the invention, it is additionally provided that, for reducing the interim bending stiffness, EJ′, of the tube to the desired target bending stiffness EJ, a volume 151′ of the stiffening element 151 is removed—that, thus, the contribution of the stiffening element to the total interim bending stiffness EJ′ of the tube is reduced, in given cases, also successively reduced. Taking this into consideration, the at least one stiffening element 151 is additionally so affixed on the tube and, at the start, also so dimensioned, that the thus introduced, interim bending stiffness of the tube is, as a result, not only greater than the initial-stiffness of the starting tube, but, also, at first, also greater than the target bending stiffness EJ.

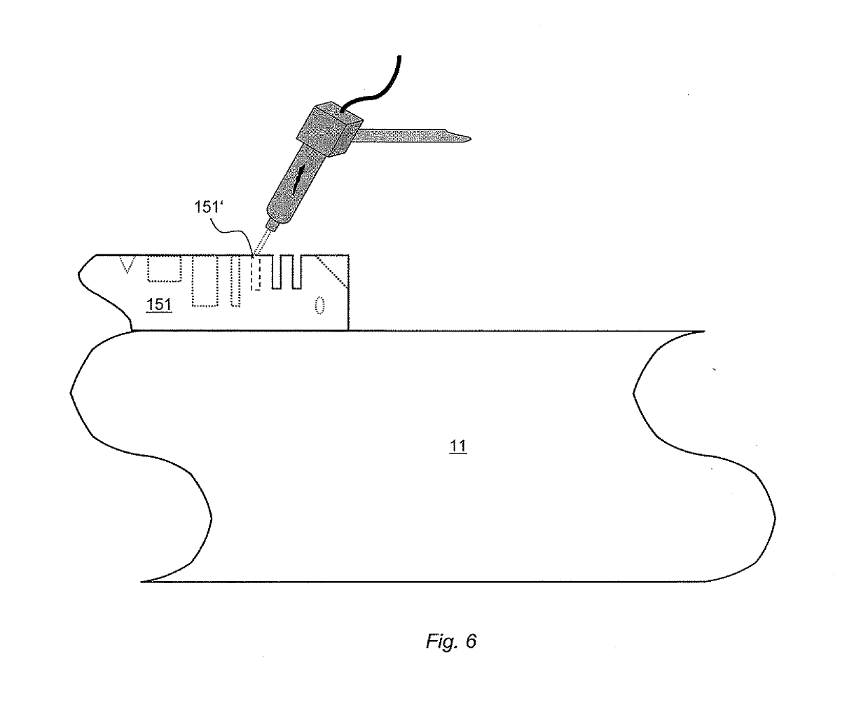

The removing can occur, for example, by cutting off and/or grinding off an edge of the stiffening element, by inserting one or more notches, in given cases, also notches equidistant from one another, by introduction of holes, and/or, as schematically presented in FIG. 6, by cutting-in one or more slits or slots, in given cases, also mutually parallel and/or equidistant slits or slots, into said stiffening element 151.

The interim bending stiffness EJ′ of the tube, and also the finally achieved target bending stiffness EJ, can be ascertained, in manner known per se to those skilled in the art, for example, metrologically, sufficiently exactly, for instance, as also described in the initially mentioned WO-A 2005/050145, after installation of the finished tube arrangement, or after manufacture of the inner part, through introduction of a—static or also changing, consequently dynamic—defined force, for instance, via exciter mechanism 40, and measuring a deflection of the tube resulting therefrom, for instance, by means of at least one of the oscillation sensors 51, 52 and/or a path measuring sensor placed suitably therefor, for example, in the form of laser based, sensor equipment.

Alternatively, or in supplementation, for the aforementioned force introduction, distance measuring, using the functional dependence, typically sufficiently known for the given tube (or a tube arrangement formed therewith), of inherent mechanical eigenfrequencies on the instantaneous bending stiffness of the tube, it is possible, very simply and in good approximation, thereby quantitatively to ascertain to what extent the interim bending stiffness EJ′ of the tube deviates from the target bending stiffness EJ. To do this, the tube is caused to vibrate at at least one of the instantaneous eigenfrequencies, consequently in a corresponding eigenmode, and a discrepancy between this instantaneous eigenfrequency and an eigenfrequency earlier determined, or expected, for said eigenmode is ascertained. This can be advantageous sufficiently and because of its simple implementability, for example, for the above described case, in which the measuring transducer has a tube arrangement formed by means of two measuring tubes, where mainly an as exact as possible tuning of the oscillation characteristics of the two measuring tubes relative to one another, consequently the target bending stiffness EJ of the one of the two measuring tubes relative to the corresponding bending stiffness of the other of the two measuring tubes, is desired. Particularly for the mentioned case, in which the interim bending stiffness EJ′ of the tube is to be ascertained for the purpose of matching one or more eigenfrequencies of a tube arrangement formed by means of two tubes, or measuring tubes, or the tube serving ultimately as first measuring tube 11 is to be correspondingly matched as regards its target bending stiffness EJ to the second measuring tube 12—here thus a tube serving as a comparison, or reference, tube—, it is, according to an additional embodiment of the invention, provided that the tube is caused to vibrate—, for instance, after manufacture of the tube arrangement having said tube, in given cases, also with the tube arrangement already placed in its ultimate installed position in the measuring transducer housing 100,—for the purpose of ascertaining its current interim bending stiffness, especially at a mechanical eigenfrequency decisively co-determined by said interim bending stiffness; this, especially, also before the step of removing volume of the stiffening element is performed. The causing of the tube to vibrate for the purpose of ascertaining its interim bending stiffness can occur, for example, when the comparison tube 12 is temporarily affixed in a manner interfering with oscillations of the same, for instance, by being clamped tightly. Alternatively thereto or in supplementation thereof, the comparison tube can, however, also, as already mentioned, be caused likewise to vibrate, for instance, for ascertaining the target bending stiffness EJ for the tube and/or when the tube is temporarily affixed in a manner interfering with oscillations of the same.

At least for introducing the force via the exciter mechanism 40 for the purpose of causing the tube to vibrate, as well as also for detecting vibrations of the tube resulting therefrom, in the case of readied inner part, for example, the transmitter electronics intended for the finally manufactured measuring system can be used, but, instead of this, also a comparable test electronics remaining with the manufacturer can also be used.

For the purpose of ascertaining the actual instantaneous, interim, bending stiffness EJ′, or the finally achieved target bending stiffness EJ, for instance, in order to provide supplemental information for a later diagnosis of the measuring transducer according to the mentioned WO-A 2005/050145,—alternatively or supplementally to the aforementioned ascertaining of the instantaneous deviation of the interim bending stiffness from the target bending stiffness based on measurements of eigenfrequencies—it is provided, according to an additional embodiment, that a mass of the tube co-determining the at least one eigenfrequency of the tube operative for ascertaining the interim—, or target, bending stiffness is earlier determined, for example, by weighing the respective tube, or the starting tube and the at least one stiffening element and/or by weighing another tube of equal type. The so ascertained, target bending stiffness EJ can, for example, be subsequently also stored in the transmitter electronics, for instance, in the mentioned non-volatile data memory EEPROM, and, thus, be available for later testing of the measuring transducer.

For removing volume of at least the at least one stiffening element 151, laser light can be used, applied e.g. by means of a gas laser, such as, for instance, a CO2 laser, by means of a solid laser, such as, for instance, a pulsed ND:YAG-laser, or also by means of a fiber laser. The application of laser light introduces, among other things, also the advantage that said removing of volume of the stiffening element can be performed largely in an automated manner, for example, by means of robots, even in the case of vibrating tube, particularly also in the case of a tube vibrating at an instantaneous eigenfrequency co-determined by the current interim bending stiffness. For the latter case, it is possible in this way, for example, alternately to remove a defined volume and thereafter to detect without delay, based on the then correspondingly excited vibrations, whether the tube has now been trimmed to the target bending stiffness, or whether there is still an instantaneous deviation of the current interim bending stiffness from the desired target bending stiffness, based on which, with continuous registering of the instantaneous eigenfrequency corresponding to the current interim bending stiffness and through correspondingly “metered”, further removing of volume, for instance, through cutting in of one or more, further slits or slots further reducing to an acceptable value for the deviation, consequently the interim bending stiffness, very quickly coming to the desired target bending stiffness. Alternatively, or in supplementation, to laser light, for example, however, also a chip removing tool, in given cases, a chip removing tool even only manually operated, such as, for instance, a file, or a chip removing method for removing of volume of the stiffening element can be applied.

Although the invention has been explained above only with reference to one stiffening element 151, it is to be noted here that, of course, particularly also for the purpose of an additional improving of the precision, with which the target bending stiffness is set, and/or for the purpose of creating the opportunity for being able to trim selectively to, in each case, effective target bending stiffnesses for various eigenmodes—, for instance, the wanted mode, or the thereto corresponding, Coriolis mode—, also two or more such stiffening elements can be arranged distributed on the tube. Consequently, thus, the method of the invention can additionally include a step of applying at least one additional stiffening element 151′, for example, of metal and/or a material bondable with the material of the tube and/or platelet shaped, on a lateral surface of the tube for effecting the interim bending stiffness EJ′ of the tube. Furthermore, it can also be advantageous to arrange the at least one stiffening element not only, as shown in FIGS. 4, and, respectively, 5, by way of example, in an inlet—, or outlet, region of the tube—consequently in a region, in which bending oscillations of the finally formed measuring tube 11 effect in the tube, both in the wanted—as well as also in the Coriolis mode, deformations of comparatively large extent, especially in the form of twisting,—, but, also to place such—exclusively or supplementally—, for example, also in a middle region of the (measuring-) tube—consequently in a region in which, regularly, bending oscillations of the measuring tube 11 occur in the wanted-mode with larger deformations of the tube than, for example, those in the Coriolis-mode—, and, in given cases, also correspondingly partially to remove volume from such. For the rest, supplementally, also the comparison tube equally as the tube, consequently the second measuring tube 12, same as the first measuring tube, can have one or more such stiffening elements of the aforementioned type, in given cases, also then to be reduced by a certain volume after installation.

1. A method for trimming a tube to a target bending stiffness, especially a metal tube and/or a tube serving as a measuring tube of a measuring transducer of a vibration-type, such tube having a tube wall, especially a tube wall of metal and/or an at least sectionally, circularly cylindrical, tube wall, and at least one stiffening element, especially a metal stiffening element, and/or a stiffening element of a material bondable with the material of the tube and/or a platelet shaped stiffening element, placed on the tube wall, especially on an outer lateral surface of the tube wall and/or bonded thereto, wherein the tube has an interim bending stiffness, which is greater than the target bending stiffness, which method comprises a step of:
removing a volume the stiffening element for reducing the interim bending stiffness of the tube to the target bending stiffness.

2. The method as claimed in claim 1, further comprising:
a step of detecting whether the tube has been trimmed to the target bending stiffness, especially based on at least one mechanical eigenfrequency of the tube or a tube arrangement formed by means of the same; and/or
a step of ascertaining to what extent an instantaneous, interim, bending stiffness of the tube deviates from the target bending stiffness, especially based on at least one mechanical eigenfrequency of the tube.

3. The method as claimed in claim 1, further comprising a step of:
ascertaining the target bending stiffness of the tube.

4. The method as claimed in claim 1, further comprising a step of:
ascertaining the interim bending stiffness of the tube.

5. The method as claimed in claim 1, further comprising a step of:
causing the tube to vibrate for ascertaining its interim bending stiffness.

6. The method as claimed in claim 1, further comprising a step of:
forming a tube arrangement having the tube as well as a comparison tube mechanically coupled therewith.

7. The method as claimed in claim 6, further comprising a step of:
causing the comparison tube to vibrate, especially at a mechanical eigenfrequency of the tube arrangement, for ascertaining the target bending stiffness for the tube and/or for ascertaining the interim bending stiffness of the same.

8. The method as claimed in claim 1, wherein:
at least one oscillation exciter is placed on the tube; and/or
at least one oscillation sensor is placed on the tube.

9. The method as claimed in claim 1, wherein:
laser light is used for removing volume of the stiffening element; and
the laser light is applied especially by means of a gas laser, by means of a solid laser or also by means of a fiber laser.

10. The method as claimed in claim 1, wherein:
the removing of volume of the stiffening element comprises a step of cutting at least one slit or slot in the stiffening element.

11. The method as claimed in claim 1, wherein:
the removing of volume of the stiffening element comprises a step of grinding at least one notch in the stiffening element.

12. The method as claimed in claim 1, wherein:
the stiffening element is applied on the lateral surface of the tube by means of welding and/or soldering, especially hard soldering, or brazing.

13. The method as claimed in claim 1, wherein:
the stiffening element is rod or bar shaped.

14. The method as claimed in claim 1, wherein:
the stiffening element is plate shaped.

15. The method as claimed in claim 1, wherein:
the stiffening element is formed by means of wire, especially metal wire.

16. The method as claimed in claim 1, wherein:
the stiffening element is formed by means of a platelet, especially a metal platelet.

17. The method as claimed in claim 1, wherein:
the stiffening element is formed by means of solder material applied on the lateral surface, especially beaded or spotted, solder material.

18. The method as claimed in claim 1, wherein:
the stiffening element is formed by means of a ridge of solder material.

19. The method as claimed in claim 1, further comprising a step of:
applying at least one additional stiffening element on a lateral surface of the tube, especially an additional stiffening element of metal and/or a material bondable with the material of the tube and/or a platelet shaped, additional stiffening element.

20. The method as claimed in claim 19, wherein:
the applying of the additional stiffening element on the lateral surface of the tube comprises applying liquid solder material on the lateral surface of the tube and letting applied liquid solder material solidify on the lateral surface of the tube.

21. The use of a tube trimmed according to a method as claimed in claim 1 to a target bending stiffness in a measuring transducer of the vibration-type, especially in a measuring transducer of a Coriolis, mass flow, measuring device.
